(19) United States
(12) Patent Application Publication
(10) Pub. No.: US 2024/0312444 A1
(43) Pub. Date: Sep. 19, 2024

(54) Magnetic String Instrument Pickups with Offset Coil Former

(71) Applicant: 4437959 Nova Scotia Limited, Fall River (CA)

(72) Inventor: Michael Jeffrey Brunt, Fall River (CA)

(21) Appl. No.: 18/605,920

(22) Filed: Mar. 15, 2024

Related U.S. Application Data
(60) Provisional application No. 63/490,418, filed on Mar. 15, 2023.

(51) Int. Cl. G10H 3/18

(52) U.S. Cl. CPC G10H 3/181; G10H 2220/461

(57) ABSTRACT

Among other things, in general, the present disclosure relates to a string instrument pickup wherein the coil is intentionally rotated and/or offset with the magnetic field, or wherein the coil targets specific areas of the magnetic field, creating a more complex and rich tonal character. The present disclosure also relates to methods of manufacture of string instrument pickups.

### CROSS-REFERENCE TO RELATED APPLICATIONS

This application claims the benefit of U.S. Provisional Patent Application Ser. No. 63/490,418, filed Mar. 15, 2023, the contents of which are hereby incorporated by reference in their entirety.

### FIELD OF THE DISCLOSURE

The present disclosure relates to string instrument pickups.

### BACKGROUND

One of the primary challenges in guitar and other string instrument pickup design is to create a sound that is tonally rich, complex, and distinctive, while also delivering a desirable range or electrical output.

Conventional guitar pickups use a design where the coil is aligned in position with the magnet(s), and the exhibited magnetic field is perpendicular both to the plane of the coil and to the position of the strings at rest. For example, a conventional guitar pickup will have one or more permanent magnets inserted or threaded into a supporting assembly (e.g., a bobbin or coil former with appropriate mounts) that is then wound with many turns of insulated copper wire, forming an induction coil that is in-plane with the magnets. Some pickups have magnets installed entirely inside the coil, while others are installed somewhat or completely below the coil. Regardless of the pickup design, the electromagnetic principle is similar: when installed on a string instrument with metal-containing strings, the permanent magnets will magnetically interact with the metal strings. Changes in the position of the string (e.g., when it is strummed or plucked) result in a change in the magnetic field that results in an induced current in the pickup coil. This current is then amplified to produce sound.

The perpendicular nature of the induction coil with respect to the magnetic field means that the inductive effect can be easily calculated and executed. In principle, winding the wire around a coil former can be accomplished entirely using mechanical winding apparatus; but a coil that is wound electrically “perfectly” to minimize wire crossovers and in-coil crosstalk is widely considered to have poor tonal characteristics. In practice, producing tonal quality in the conventional arrangement is something that requires careful introduction of what otherwise might be considered winding “imperfections”.

As such, conventional guitar pickups often lack desirable tonal characteristics without extremely skillful craftsmanship, often relying on the individual winder as an artist to control the vertical spacing of wires while winding tens, hundreds, or even thousands of meters/yards of wire on a single pickup. The tonal quality is highly influenced by the gauge, length, and tightness of the winding, as well as to what extent automation is used to accomplish the winding, the machine used, and at what points in the winding process. In addition to the impractical construction technique, the capacitance and inductance of the conventional guitar pickup is highly influenced by the winding. Thus even a skilled designer or artist is limited in the combinations of harmonic richness and “thickness” that can be produced.

There have been some previous attempts to create guitar pickup designs that can produce different tones. For example, some previous designs used different types of magnets or pole pieces, and others used multiple coils. The presence of pole pieces (poles of ferromagnetic material either attached to or in the vicinity of one or more magnets, and generally positioned so as to be underneath string positions at rest) is thought to influence the magnetic field so as to provide more single-string definition. Slugs or base plates may also be used to influence the magnetic field.

The above information is presented as background information only to assist with an understanding of the present disclosure. No assertion or admission is made as to whether any of the above, or anything else in the present disclosure, unless explicitly stated, might be applicable as prior art with regard to the present disclosure. There remains a need for string instrument pickups, and articles and methods of their assembly, that have consistently good tonal characteristics.

### SUMMARY

The present disclosure relates to a string instrument pickup wherein the coil is intentionally offset and/or rotated with the magnetic field(s) generated by the magnet(s) of the pickup. By offsetting and/or rotating the coil with respect to the magnet(s), the magnetic field lines intersect the coil at different strengths and angles, causing a more complex, harmonic-rich sound to be produced.

Among other things, in general, string instrument pickup assemblies, coil formers, and methods of manufacture thereof are disclosed. Pickups disclosed herein have one or more permanent magnets and an induction coil, and the magnets and the coil are separately oriented such that any electric field induced in the coil would not perfectly align with the permanent magnet magnetic field. When in the presence of objects that interact with the magnetic field, e.g., moving instrument strings, the current induced in the coil is rotated with respect to the magnetic field, translated with respected to the magnetic field, and/or preferentially focused/targeted upon a part of the magnetic field. Pickups so constructed exhibit novel acoustic qualities when installed and operating upon a string instrument.

In general, in an aspect, a string instrument pickup assembly has one or more permanent magnets and an induction coil, where the one or more permanent magnets are positioned so as to exhibit an anisotropic magnetic field aligned along a long axis, and the induction coil has turns of wire positioned so as to be capable of capturing induced current from movement of instrument strings, wherein the turns of wire are wrapped so as to have a long axis of alignment that is rotated from parallel or translationally offset with respect to the magnetic field long axis of alignment.

Implementations of the above may include one or more of the following. The coil long axis of alignment is a rotation angle from parallel with respect to the magnetic field axis of alignment. The coil long axis of alignment is translationally offset from the magnetic field long axis of alignment. The magnetic field long axis of alignment is approximately perpendicular to the instrument strings at rest when installed upon the string instrument. The long axis of alignment of the turns of wire is neither parallel nor perpendicular to the magnetic field axis of alignment. The rotation angle is between about 1 and about 20 degrees. The offset is between about 0.1 mm and about 50 mm. The turns of wire are wrapped upon a curved coil former, whereby a part of the magnetic field is targeted. The turns of wire are wrapped upon a stepped coil former, whereby a part of the magnetic field is targeted. The turns of wire are wrapped upon a coil former configured to accept discrete additional turns of wire and the additional turns of wire are positioned differently from the turns of wire, whereby a part of the magnetic field is targeted.

In general, in an aspect, a coil former for assembly of a string instrument pickup is disclosed. The former has one or more mounts for installation of permanent magnets, with the mounts positioned so as to cause the one or more permanent magnets to exhibit an anisotropic magnetic field aligned along a long axis. The former also has a frame configured for wrapping of turns of wire, the frame shaped so as to cause the turns of wire to exhibit a long axis of alignment that is an offset angle from parallel with respect to the magnetic field long axis of alignment.

In general, in an aspect, a method of manufacture of a string instrument pickup assembly for picking up movement of instrument strings is disclosed, the assembly configured to accept one or more permanent magnets, whereby when installed upon the assembly the one or more permanent magnets exhibit a magnetic field having a long axis of alignment, the method comprising winding turns of wire upon the pickup assembly such that the turns of wire exhibit a long axis of alignment that is a rotation angle from parallel with the magnetic field long axis of alignment. Implementations may include one or more of the following. The string instrument pickup assembly has a coil former and the winding is performed upon the coil former. The coil former is curved. The coil former is stepped. The coil former is configured to accept discrete additional turns of wire, the method further comprising winding the additional turns of wire upon the coil former so as to target a part of the magnetic field.

Advantages of the apparatus and methods disclosed herein include one or more of the following. The string instrument pickup assembly exhibits useful acoustic effects. The pickups can be reliably manufactured so as to produce useful acoustic effects without requiring expert winding knowledge. The pickups can be manufactured to provide for any or all of induction that is rotated, translated, or targeted with respect to the magnetic field in such a way as to produce a variety of useful acoustic effects, repeatably across a product line using the methods and coil formers described herein.

The foregoing summary provides some example aspects and features according to the present disclosure. It is not intended to be limiting in any way. For example, the summary is not necessarily meant to identify important or crucial features of the disclosure. Rather, it is merely meant to introduce some concepts according to the disclosure. Other aspects and features of the present disclosure are apparent to those ordinarily skilled in the art upon review of the following description of specific example embodiments in conjunction with the accompanying figures.

### BRIEF DESCRIPTION OF DRAWINGS

FIG. 1 shows a top view of a guitar pickup with a deliberately misaligned coil.

FIG. 2 shows a perspective view of a guitar pickup.

FIG. 3 shows a side view of a guitar pickup with a non-cylindrical former.

FIG. 4 shows a section view of a magnetic field and coil around a non-cylindrical former.

FIG. 5 shows a section view of a guitar pickup with two coils.

FIG. 6 shows a pickup coil former with, e.g., a bar magnet.

FIG. 7 shows a top view of a pickup with translational offset.

### DETAILED DESCRIPTION

### Parts Legend

1 String instrument pickup assembly
10 (Induction) coil of wrapped wires/turns of wire
12 (Coil) former
14 Longitudinal axis/long axis of alignment of coil
15 Walls of the coil former
18 (Permanent) Magnet(s)
19 (Long) axis of alignment of magnets
24 Magnetic field
26 Electrical wiring inlet/terminal
28 Hole for mounting screw
30 First coil
31 Second coil
32 Separator
40 Bar magnet
50 (Linear) offset
51 Coil-magnet spacing (one side)
52 Coil-magnet spacing (other side)
α Rotation angle

The present disclosure relates to a string instrument pickup that intentionally offsets and/or rotates the coil with the magnetic field. In another aspect, the present disclosure relates to a string instrument pickup that intentionally constrains or targets the coil in particular areas of the magnetic field. Among other things, in general, by offsetting and/or rotating the coil with respect to the magnet(s), the magnetic field lines intersect the coil at different strengths and angles, causing a more complex, harmonic-rich sound to be produced. In some embodiments, providing a pickup in which the coil is “misaligned” or offset from the magnetic field of the magnet(s) can result in a unique tonal character that is rich, complex, and distinctive.

Although various embodiments and features are described herein in terms of guitar pickups, the present disclosure is directed more generally to pickups for any suitable string instruments. Thus, references to guitar pickups are not meant to be limiting in any way.

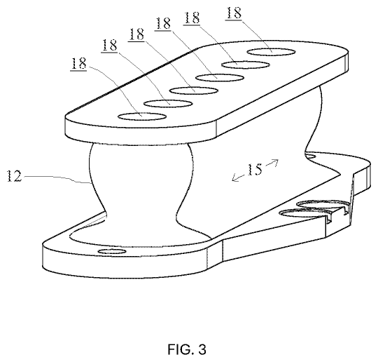

In some embodiments, alone or in combination with an offset coil, an advanced bobbin or coil former, e.g., as exemplified in FIG. 3, may be used to constrain or target the coil in a desired area(s) of the magnetic field. In some embodiments, it may be desirable to avoid placing the coil near the core of the magnet(s) since this area contributes significantly to the inductance of the pickup, thereby limiting the high frequencies that are produced. In some embodiments, it may be desirable to target the coil windings near the top of the pickup, 2 mm from the magnet, as the magnetic field in this area is relatively more responsive to the strings or other ferrous objects.

In some embodiments, the degree of offset and/or rotation of the coil with respect to the magnetic field may be selected so as to enhance tonal characteristics evocative of a particular musical genre. For example, a pickup designed to produce a classic jazz guitar tone may benefit from a coil concentrated near the center of the magnet(s).

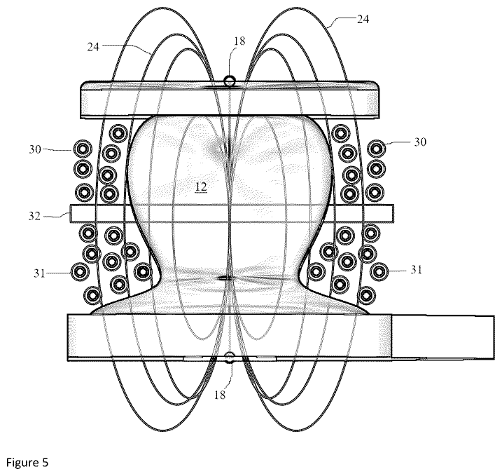

In some embodiments, the offset or misalignment, or profile, may or may not be consistent throughout the body of the pickup. Multiple coils may be employed, for example in an embodiment in FIG. 5, in or out of phase, and/or may or may not provide a degree of hum canceling ability. In some embodiments, a coil may have voids within the winding.

When considering the geometry of a string instrument pickup, a “reference surface” can be defined by the shortest planar path around the magnets as planned to be installed and the desired height of the pickup coil. At every point on this reference surface, at a direction outward and tangent to the surface, we may specify a distance from the reference surface to a point where a turn of wire would be placed in order to produce the tonal, inductive, capacitance, or other performance related characteristics desired in the overall coil. Connecting these points defines the surface of the coil former that would be premanufactured for pickups of the present disclosure, and can be recognized as different from that of a conventional guitar pickup in that the resulting coil wound upon the former will be offset or rotated or both with respect to the magnetic field exhibit by the magnets.

In an embodiment, there is provided a string instrument pickup comprising at least one magnet, and a coil that is at least one of offset and rotated with respect to the at least one magnet. In an embodiment, there is provided a string instrument pickup, wherein the rotation is an angular rotation between an axis of alignment of the at least one magnet and a longitudinal axis of the coil. In an embodiment, there is provided a string instrument pickup, wherein the angular rotation is within the range of 1 to 20 degrees. In an embodiment, there is provided a string instrument pickup, wherein the offset is within the range of 0.1 mm to about 50 mm. In an embodiment, there is provided a string instrument pickup comprising a coil and a curved, stepped, or multi coil former for targeting at least one area of the magnetic field. In an embodiment, there is provided a method of manufacturing a string instrument pickup as claimed in any of the preceding claims, winding the coil around a former, and positioning the former such that the coil(s) are at least one of offset, rotated, and targeted with respect to the at least one magnet.

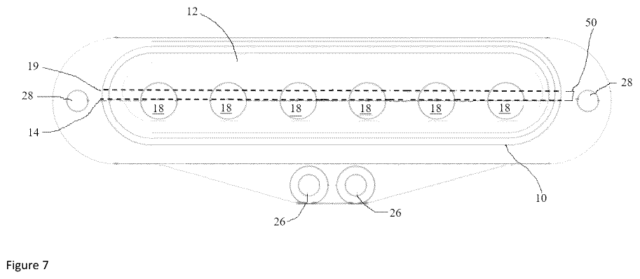

In some embodiments, the magnet(s) may be arranged so as to be perpendicular or approximately perpendicular to the guitar strings, or of any other arrangement, provided that the coil is offset or rotated compared with respect to the magnet(s). For example, in an embodiment, a linear offset (see, e.g., reference numeral 50 in FIG. 7) of around 0.25 mm measured between a center axis or line of the magnet(s) and a center axis or line of the coil can have a noticeable effect. However, in other embodiments, an offset may be of any other suitable distance. As mere examples, the offset may be 0.1 mm, 0.2 mm, 0.3 mm, 0.4 mm, 0.5 mm, 0.6 mm, 0.7 mm, 0.8 mm, 0.9 mm, 1.0 mm, or any other suitable distance smaller, between, or larger than any of these values.

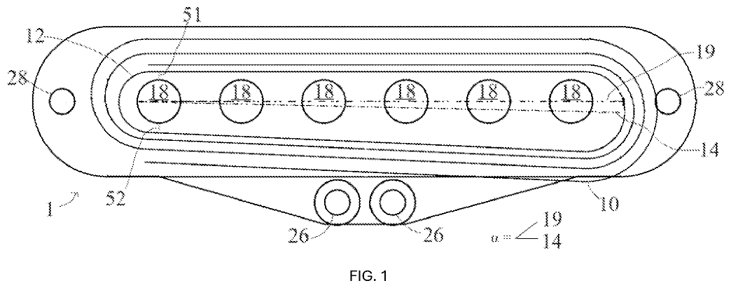

Furthermore, in an embodiment, the coil may be spaced from the magnet(s) by 1 mm (e.g., see FIG. 1, ref numeral 52 dashed line) on one side and 1.5 mm (e.g., see FIG. 1, ref numeral 51 dashed line) to the other, and the spacing may be reversed at the other end of the coil. In other embodiments, these spacings may be of any other suitable value(s), for example but not limited to 0.1 mm, 0.25 mm, 0.5 mm, 1 mm, 10 mm, 15 mm, 20 mm, 25 mm, 30 mm, 35 mm, 40 mm, 45 mm, 50 mm, or any other suitable distance smaller, between, or larger than any of these values. In some embodiments, the lower limit of spacing between coil and magnet is expected to be 0.10±0.01 mm given generally applicable manufacturing tolerances for guitar pickups.

In an embodiment, the coil may be spaced from the magnet(s) within any distance that still provides an inductive effect with respect to the magnetic field for at least part of the coil. In some embodiments, the spacing is no more than 50 mm, or no more than 51 mm, or no more than 49 mm. In some embodiments, at least part of the coil is deliberately spaced outside about 50 mm in order to add resistance and capacitance to the electrical properties of the pickup assembly without adding inductance. A skilled artisan may determine the approximate outer limit of magnet-coil spacing for a given pickup design herein by use of a magnetometer or compass. In some embodiments, the offset can be taken to the extent that sections of a coil are practically outside the magnetic field for a more pronounced effect.

Likewise, in an embodiment, a coil rotation angle (e.g., angle α shown in FIG. 1) of 9 degrees is audibly significant. However, in other embodiments, a rotation or angle may be of any other suitable value. As mere examples, an angle of rotation or offset may be 1 degree, 2 degrees, 3 degrees, 4 degrees, 5 degrees, 6 degrees, 7 degrees, 8 degrees, 10 degrees, 11 degrees, 12 degrees, 15 degrees, 20 degrees, or any other suitable angle smaller, between, or larger than any of these angles.

In some embodiments, the offset may not be consistent across the vertical axis or along the path of the coil. This advanced geometry can be used to target or constrain the coil in desirable areas of the magnetic field; changes in geometry along the path of the coil may further refine the constraint or targeting to be appropriate for specific strings. In some embodiments, the coil former may vary in shape from top to bottom. In some embodiments, the coil former may incorporate a twist. In some embodiments, the coil former may be narrower in the middle than at the top and bottom.

In some embodiments, the magnetic field produced by the pickup magnets lacks a long axis of alignment (for example, in the case of an induction coil wound around a circular ring of magnets). Such pickup designs are intended to be within the scope of this disclosure provided the resulting inductive effect is similarly rotated, offset, or targeted/focused with respect to the magnetic field. In some such embodiments, a “long axis of alignment” is defined upon one line within the plane of the magnetic field purely for convention, in order to establish positioning of the induction coil or for design of the coil former that would accommodate an isotropic magnetic field.

FIG. 1 shows a top view of a guitar pickup 1 with a misaligned coil 10 according to an example, non-limiting embodiment. The coil 10 (which in FIG. 1 is depicted as an unbroken spiral around the former) is wrapped around a former 12, which may or may not be cylindrical in profile. (By “cylindrical in profile”, we herein mean broadly that the referenced object, generally elongated, has a two-fold axis of symmetry when viewed from the top and is capped on either end in a manner that would resemble a cylinder if the elongated segment were not present.) Coil 10 has a longitudinal axis 14 (depicted using a double dotted line). In another embodiment, it may be considered that former 12 has longitudinal axis 14 inasmuch as turns of wire are wrapped around the former. The former 12 is positioned such that it is offset and rotated with respect to the magnets 18, which in this embodiment are arranged in a straight line. The line may be referred to as an axis of alignment 19 of the magnets 18. Thus, considered another way, longitudinal axis 14 of coil 10 or former 12 is rotated relative to axis of alignment 19 (depicted using a double dotted line) of the magnet(s) 18. An angle of the rotation between the magnet(s) 18 and coil 10 or former 12 is referred to as a. Considered another way, the angle of rotation between longitudinal axis 14 of coil 10 or former 12, and axis of alignment 19 of the magnet(s) 18, is referred to as α.

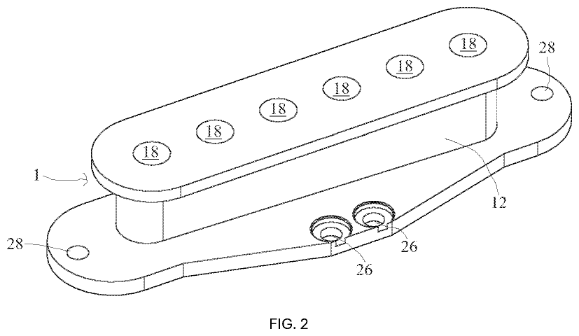

FIG. 2 shows a perspective view of a guitar pickup 1. The magnets 18 are installed into the pickup 1 shown extending upward (i.e., toward the strings when installed upon a six-stringed instrument). According to an example, non-limiting embodiment, a cylindrically shaped former 12 is shown offset and rotated with respect to the magnets 18; in this case, such that its elongated cylindrical middle section has an axis that is at an angle to the axis of the line of magnets 18 and is translationally offset from that axis.

FIG. 3 shows a side view of a guitar pickup with a non-cylindrical former 12 according to an example, non-limiting embodiment. The magnets 18 are shown extending upward. a non-cylindrical former 12 is shown with advanced geometry (i.e., with more complex shape), but without an offset of the coil misalignment as might be seen in other embodiments. In particular as to the advanced geometry, the wall(s) 15 of former 12 are not straight, but instead are curved. In other embodiments, the shape of the wall(s) 15 may have any other suitable shape, including other curved shape(s).

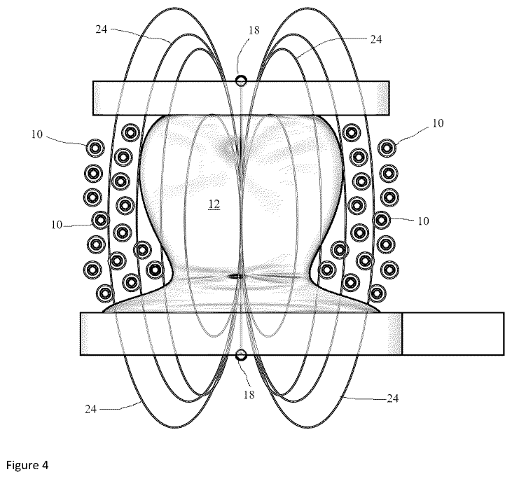

FIG. 4 shows a section view of the magnetic field and coil around a non cylindrical former 12 according to an example, non-limiting embodiment. This section view illustrates a cut through a pickup assembly having a non-cylindrical coil former 12 surrounded by a spiral winding of wire (seen cutting the turns of wire) that have been wound around the non-straight walls (not labelled) 15 of the former 12. The varying distance between the coil 10 and the magnets 18 (mounted at top or bottom; or in some embodiments, a single piece of magnetic material reaching through the top and bottom of the former 12) due to the non-straight wall(s) 15 of former 12 causes the coil 10 to be constrained, and allows the designer to target the coil where the magnetic field 24 (depicted using ellipses) responds ideally to external ferrous objects such as guitar strings. This results in select signals being induced in the coil 10, which can create a more, or less, complex waveform and add to the richness of the tone of the guitar. This allows the general inductance pickup to be controlled separately from the amount of current that can be induced.

FIG. 5 shows a section view of the guitar pickup according to an example, non-limiting embodiment with two coils 30 and 31, separated by a separator 32 applied around the former 12 to achieve vertical distance between coils 30 and 31.

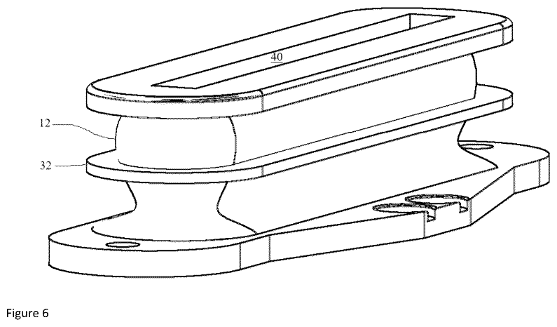

FIG. 6 shows a pickup former according to an example, non-limiting embodiment with an alternative magnet shape 40, such as a bar magnet, embedded into the top of the former; and a feature installed to separate coils 32.

FIG. 7 shows a pickup with a linear offset 50 (no rotation), which may or may not have an advanced coil former profile, according to an example, non-limiting embodiment. The linear offset 50 (depicted as a bracket between two dotted lines) is defined as a distance between the axis of alignment 19 (dotted line) of the magnet(s) 18 and longitudinal axis 14 (dotted line) of former 12. The offset may be measured at, e.g., the midway points of each of former 12 and axis of alignment 19 of the magnet(s) 18. Or in other embodiments, as shown in FIG. 7, the offset may be measured at some other point along the axes.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

The specific dimensions and angles of the coil and magnets can vary depending on the desired tonal character and other factors. It is also possible to use different types of magnets or pole pieces to achieve different tonal effects.

A coil former according to the present disclosure provides for more practical manufacturing by positioning the coil radially while it is wound by standard coil winding apparatus or by hand.

Attempting, to the extent possible, to achieve a rich and complex tone without an advanced shaped coil former requires the wire to be precisely offset axially as the coil is wound, requiring a skilled worker or advanced winding machinery.

The embodiments according to the present disclosure are intended to be examples only. Alterations, modifications and variations may be effected to the particular embodiments by those of skill in the art without departing from the scope, which is defined solely by the claims appended hereto.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated.

Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

1. A string instrument pickup assembly for picking up movement of instrument strings, the assembly comprising one or more permanent magnets and an induction coil, the one or more permanent magnets positioned so as to exhibit a magnetic field having a long axis of alignment, and the induction coil having turns of wire positioned so as to be capable of capturing induced current from movement of the instrument strings, wherein the turns of wire are wrapped so as to have a long axis of alignment that is a rotation angle from parallel with respect to the magnetic field long axis of alignment.

2. The assembly of claim 1 in which the magnetic field long axis of alignment is approximately perpendicular to the instrument strings at rest when installed upon the string instrument.

3. The assembly of claim 1 in which the long axis of alignment of the turns of wire is neither parallel nor perpendicular to the magnetic field axis of alignment.

4. The assembly of claim 1 in which the rotation angle is between about 1 and about 20 degrees.

5. The assembly of claim 1 in which the long axis of alignment of the turns of wire is translationally offset from the magnetic field long axis of alignment.

6. The assembly of claim 5 in which the offset is between about 0.1 mm and about 50 mm.

7. The assembly of claim 1 in which the turns of wire are wrapped upon a curved coil former, whereby a part of the magnetic field is targeted.

8. The assembly of claim 1 in which the turns of wire are wrapped upon a stepped coil former, whereby a part of the magnetic field is targeted.

9. The assembly of claim 1 in which the turns of wire are wrapped upon a coil former configured to accept discrete additional turns of wire and the additional turns of wire are positioned differently from the turns of wire, whereby a part of the magnetic field is targeted.

10. A string instrument pickup assembly for picking up movement of instrument strings, the assembly comprising one or more permanent magnets and an induction coil, the one or more permanent magnets positioned so as to exhibit a magnetic field having a long axis of alignment, and the induction coil having turns of wire positioned so as to be capable of capturing induced current from movement of the instrument strings, wherein the turns of wire are wrapped so as to have a long axis of alignment that is translationally offset from the magnetic field long axis of alignment.

11. The assembly of claim 10 in which the offset is between about 0.1 mm and about 50 mm.

12. The assembly of claim 10 in which the turns of wire are wrapped upon a curved coil former, whereby a part of the magnetic field is targeted.

13. The assembly of claim 10 in which the turns of wire are wrapped upon a stepped coil former, whereby a part of the magnetic field is targeted.

14. The assembly of claim 10 in which the turns of wire are wrapped upon a coil former configured to accept discrete additional turns of wire and the additional turns of wire are positioned differently from the turns of wire, whereby a part of the magnetic field is targeted.

15. A coil former for assembly of a string instrument pickup, the former having one or more mounts for installation of permanent magnets, the one or more mounts positioned so as to cause the one or more permanent magnets to exhibit a magnetic field having a long axis of alignment, and the former having a frame for wrapping of turns of wire, the frame shaped so as cause the turns of wire to exhibit a long axis of alignment that is an offset angle from parallel with respect to the magnetic field long axis of alignment.

16. A method of manufacture of a string instrument pickup assembly for picking up movement of instrument strings, the assembly configured to accept one or more permanent magnets, whereby when installed upon the assembly the one or more permanent magnets exhibit a magnetic field having a long axis of alignment, the method comprising winding turns of wire upon the pickup assembly such that the turns of wire exhibit a long axis of alignment that is a rotation angle from parallel with the magnetic field long axis of alignment.

17. The method of claim 16 in which the string instrument pickup assembly has a coil former and the winding is performed upon the coil former.

18. The method of claim 17 in which the coil former is curved.

19. The method of claim 17 in which the coil former is stepped.

20. The method of claim 17 in which the coil former is configured to accept discrete additional turns of wire, the method further comprising winding the additional turns of wire upon the coil former so as to target a part of the magnetic field.
